(19) United States
(12) Patent Application Publication
(10) Pub. No.: US 2007/0101109 A1
(43) Pub. Date: May 3, 2007

(54) Processor and method for checking a condition for conditional execution of a program command

(75) Inventors: Xiaoning Nie, Neubiberg (DE); Jinan Lin, Ottobrunn (DE)

Correspondence Address: Maginot, Moore & Beck, Chase Tower, 111 Monument Circle, Suite 3250, Indianapolis, IN, 46204, US

(73) Assignee: Infineon Technologies AG, Munich (DE)

(21) Appl. No.: 11/584,810

(22) Filed: Oct. 20, 2006

(30) Foreign Application Priority Data
Oct. 20, 2005 (DE) 10 2005 050 382.9

(51) Int. Cl. G06F 9/44

(52) U.S. Cl. 712/236

(57) ABSTRACT

A processor comprises checking and control devices, first register, and register bank. The control device checks a condition or a subcondition of the condition within a first time unit based on a first subcondition checked within a second time unit preceding the first time unit, a second subcondition checked within a third time unit preceding the second time unit, and a single condition. The first register is coupled to the control device for storing the checked condition and the output of the first register is coupled to the control device for providing the stored, checked subcondition as a checked, first subcondition. The input of the register bank is coupled to the first register for receiving the stored, checked subcondition, the second register stores the received, checked subcondition as the checked, second subcondition, and the register bank is coupled to the control device for providing the checked, second subcondition.

### BACKGROUND OF THE INVENTION

The invention relates to a processor and a method for checking a condition for conditional execution of a program command.

The technical field of the invention relates to the conditional execution of program commands by a processor, particularly by a processor with a pipeline architecture.

Conditional execution of the relevant program command by the processor is dependent on a predetermined condition, for example a state of the processor. One known example in this regard are conditional jumps, known as “branches”, where the control of the command flow is changed on the basis of a predetermined status of the process. However, besides the jump commands, there are also program commands or instructions which need to be executed on the basis of a prescribed condition, for example when the execution of the relevant program command is dependent on a predetermined processor state.

Such conditionally executed instructions are usually called predicated instructions. Such predicated instructions are especially significant for processors which have a parallel architecture. Examples of such parallel processor architectures are the Very Long Instruction Word (VLIW) architecture or the Single Instruction Multiple Data (SIMD) architecture. Both architectures have a plurality of functional units which operate simultaneously or contemporaneously. Both the VLIW architecture and the SIMD architecture exploit instruction and data independencies in order to increase their performance. This exploitation is impeded or prevented if some conditional control functions or conditions are used for a plurality of the independent operations or data items. The article “A Quantitative Approach” by the authors J. L. Hennessy and D. A. Patterson, which appeared in Elservier Science, 2003, proposes a method where this problem can be circumvented using parallelized or vectorized, conditional predicates. In the case of this method, each elementary operation or instruction and each elementary data item is provided with its own conditional predicate which decides about execution.

However, a problem with the conditional execution of program commands exists in the case of complex conditions comprising a logic function for a multiplicity of single conditions. As demands on processors increase, for example in the case of image processing, the complexity of the conditions for the conditional execution of single program commands for processing the image information also increases. The following source code 1 shows a complex condition which is formed from the single conditions a-f:

Source Code 1:

If ((a>b)&&(c==d)||(e!=f) . . . )

Another example of a complex condition is shown by the nested condition below (source code 2), which comprises If Then loops and If Then Else loops:

Source code 2:

| | |
|---|---|
| If(a>b) | { |

| | |
|---|---|
| If(c==d) | { |

... ...

}else {

... ...

}

}else}

... ...

}

In principle, any complex condition can be represented as a sequence comprising a multiplicity of single conditions. By way of example, both source codes above can be implemented using a sequence of jumps or jump commands with simple single conditions. However, this generates significant additional complexity, since a much larger number of single conditions need to be checked in order to represent the complex conditions. This significantly reduces the performance of the processor used. In addition, there is a marked increase in the memory space requirement on account of the increased number of single commands and the increased number of jump commands and also their latencies, known as “delay penalties”.

All in all, three different approaches are known for implementing conditional execution of programming commands: the Composite Instruction approach, the Condition Register approach and the Condition Code approach.

The Composite Instruction approach, which is known to the applicant internally, combines testing of the condition and the conditional execution within a single program command or a single instruction. However, integrating the testing of the condition in a single instruction results in an increase in the size of the word of the program command and hence in an increase in the memory space requirement. In addition, the processor used needs to process a program command word with a greater length. This further reduces the performance of the processor.

The Condition Register approach uses specifically provided instructions which check the state of the processor and generate a condition predicate for one or more program commands. Such a Condition Register approach is known from the datasheet “MIPS32 4Kc™ Processor Core Datasheet”, for example, which was published on the Internet page www.mips.com on the date of registration of the present patent application, and from the document US 20040064683 A1. A drawback of the Condition Register approach is that instructions for generating the predicates are additionally used for the conditional execution. The additional instructions require additional program commands in the processor's pipeline, an increased amount of memory space for these and for the predicates and also an increased need for clock cycles for executing them.

The Condition Code approach uses already available hardware in the processor, such as the status register, to indicate a condition for the processor state which is used for the conditional execution of the respective program command. One particular advantage of the Condition Code approach is that setting or checking the condition does not burden the processor's pipeline and it is therefore not necessary to use any additional program commands or clock cycles. Furthermore, the program commands in the processor used do not need to be complemented by one or more additional bits, as in the above approaches for the conditional execution of the program command. One example of the Condition Code approach is described in the document U.S. Pat. No. 6,760,831 A. The document U.S. Pat. No. 6,760,831 A describes conditional execution in a VLIW processor, in which the current condition is checked and set on the basis of the current flags in the processor, buffer-stored flags in the processor and a single and already checked, stored condition.

Regardless of the flags in the processor, the current condition is checked and set on the basis of a single, previously checked and stored condition. However, this means that it is not possible to check complex conditions which are formed from a plurality of single conditions and, in particular, are nested.

### BRIEF DESCRIPTION OF THE INVENTION

A processor for the conditional execution of program commands comprises a checking apparatus for checking a condition which is in the form of a logic function for a plurality of single conditions, wherein a checked condition indicates whether one or more operations, particularly operations which can be executed in parallel, in a program command which has been loaded and decoded by the processor are to be executed, the checking apparatus comprises:
a) a control apparatus which checks the condition or a subcondition of the condition in a predetermined first time unit on the basis of a first subcondition, checked in the preceding second time unit, and a second subcondition, checked in a third time unit coming before the second time unit, and a single condition;
b) a first register whose input side is coupled to the control apparatus for the purpose of storing the checked condition or subcondition and whose output is coupled to the control apparatus for the purpose of providing the stored, checked subcondition as a checked, first subcondition; and
c) a register bank whose input side is coupled to the first register for the purpose of receiving the stored, checked subcondition, which has at least a second register for storing the received, checked subcondition as a checked, second subcondition and which is coupled to the control apparatus for the purpose of providing the checked, second subcondition.

In addition, the invention provides a method for checking a condition for conditional execution of one or more operations in a program command which has been loaded and decoded by a processor, which condition is in the form of a logic function for a plurality of single conditions comprising the following steps:
a) a subcondition of the condition is checked and the checked subcondition is provided;
b) the provided, checked subcondition is stored as a second subcondition;
c) a further subcondition of the condition is checked and the checked further subcondition is provided;
d) the provided, checked further subcondition is stored as a first subcondition;
e) a single condition is provided; and
f) the condition or a further subcondition is checked on the basis of the stored, first subcondition, the stored, second subcondition and the provided single condition.

The invention therefore makes it possible to check a complex condition which has a plurality of single conditions. The invention does not require the format of the processor's program command to be extended by one or more bits for the conditional execution. This saves memory space, and the processor's performance is not restricted by the conditional execution of program commands which results from checking a complex condition.

The control apparatus may check the condition or the subcondition of the condition in a predetermined i-th time unit on the basis of the first subcondition, checked in a preceding (i−1)-th time unit, and the second subcondition, checked in a time unit coming before the (i−1)-th time unit, and the relevant single condition.

The subcondition may be in the form of an only single condition or in the form of a logic function for a plurality of single conditions. The fact that even a subcondition may be in the form of a plurality of the single conditions means that the condition which is to be checked may also be in the form of a nested condition. A nested condition may have a multiplicity of loops, particularly If Then loops and If Then Else loops.

The register bank may be in the form of a line comprising a plurality of second registers, with a first of the second registers being coupled to the control apparatus and to the first register and storing the second subcondition. This means that it is possible to store and provide a multiplicity of already checked subconditions of the condition. The first of the second registers always stores the subcondition identified as second subcondition. The fact that the first of the second registers is coupled to the control apparatus means that the second subcondition is always ready on the control apparatus. This means that it is therefore not necessary for the respective second subcondition to be loaded first. This prevents potential waiting times or latencies.

The line of second registers may be designed to store a predetermined plurality of the checked subconditions in an order based on their check's respective time units. This means that ordered storage of the already checked subconditions of the condition is advantageously provided. Only ordered storage of the already checked subconditions allows further, transparent use thereof for a logic function and hence for checking and determining the condition or a further subcondition of the condition.

A command decoding unit may be provided which is coupled to the control apparatus and/or to the register bank, decodes a program command loaded by the processor and, on the basis of the decoded program command, provides a first control command for controlling the control apparatus and/or a second control command for controlling the register bank. Preferably, the command decoding unit may be coupled to the control apparatus and to the register bank and, on the basis of the decoded program command, provides the first control command for controlling the control apparatus and the second control command for controlling the register bank. Advantageously, the check on the condition or on a further subcondition on the basis of the current single condition, the first subcondition and/or the second subcondition may be controlled using the first control command. The second control command may advantageously be used to control the register bank so as to take the multiplicity of the subconditions stored in the register bank and provide, as a second subcondition in the first of the second registers, the one which is needed for the subsequent check by the control apparatus.

The control apparatus may comprise a first logic circuit and/or a second logic circuit. Preferably, the first logic circuit may receive at least a status flag for the processor, which indicates at least a status for the processor and, by way of example, is in the form of a zero flag, and determines the current single condition on the basis of this. The current single condition may be generated using one or more status flags for the processor. Preferably, the respective status flags may be stored and provided by a status register in the processor. The second logic circuit may take the single condition, the first subcondition and the second subcondition as a basis for checking the condition or a further subcondition of the condition and providing the result as a checked condition or subcondition. Another advantage of the invention is that the condition or a subcondition is determined on the basis of up to three parameters, with two of these three parameters being already checked parts of the condition, which means that the condition and also the respective subcondition may be in the form of a nested or complex condition. As the complexity of the condition or subcondition to be checked increases there is also an increase in the performance of the inventive processor.

In line with another embodiment, the command decoding unit may use the first control command to provide the control apparatus with one or more rules, as below, for checking the condition or the subcondition:
a first rule which is used to update the first register with a negation for the first subcondition;
a second rule which is used to update the first register with the single condition;
a third rule which is used to update the first register with a logic AND function for the first subcondition and the single condition;
a fourth rule which is used to update the first register with the second subcondition;
a fifth rule which is used to update the first register with a logic OR function for the first subcondition and the second subcondition; and
a sixth rule which is used to update the first register with a logic AND function for the first subcondition and the second subcondition.

Advantageously, this small and hence memory-efficient command set of rules can be used to perform a multiplicity of operations for checking the condition or a subcondition.

In line with another embodiment, the second control command is in the form of a push command, which is respectively used to update the n-th second register with a value from the (n−1)-th register, which is upstream in the line, and the first second register with the first subcondition, or in the form of a pop command, which is respectively used to update the n-th second register with a value from the (n+1)-th second register, which is downstream in the line. Advantageously, the register bank can be controlled by means of the two commands, the push command and the pop command, such that the checked subcondition, required for the subsequent check by the control apparatus, is stored as second subcondition in the first of the second registers and, as a result of the coupling to the control apparatus, is applied thereto. The fact that the respective second subcondition is applied to the control apparatus means that it does not need to be loaded first. This saves time.

The time unit may be in the form of a clock cycle in the processor or in the form of a predetermined portion of the clock cycle.

### DESCRIPTION OF THE SEVERAL VIEWS OF THE DRAWINGS

The invention is explained in more detail below using the exemplary embodiments which are indicated in the schematic figures of the drawing, in which:

FIG. 1 is a schematic block diagram of a first exemplary embodiment of a processor.

FIG. 2 is a schematic block diagram of an exemplary embodiment of a control apparatus.

FIG. 3 is a schematic flowchart of an exemplary embodiment of the inventive method.

FIG. 4 is a table to illustrate the inventive check on an exemplary embodiment of a complex condition.

FIGS. 5a and 5b are each a table to illustrate the inventive check on an exemplary embodiment of a complex, nested condition.

### DETAILED DESCRIPTION OF THE INVENTION

In all the figures, elements and signals which are the same or have the same function have been provided with the same reference symbols—unless stated otherwise.

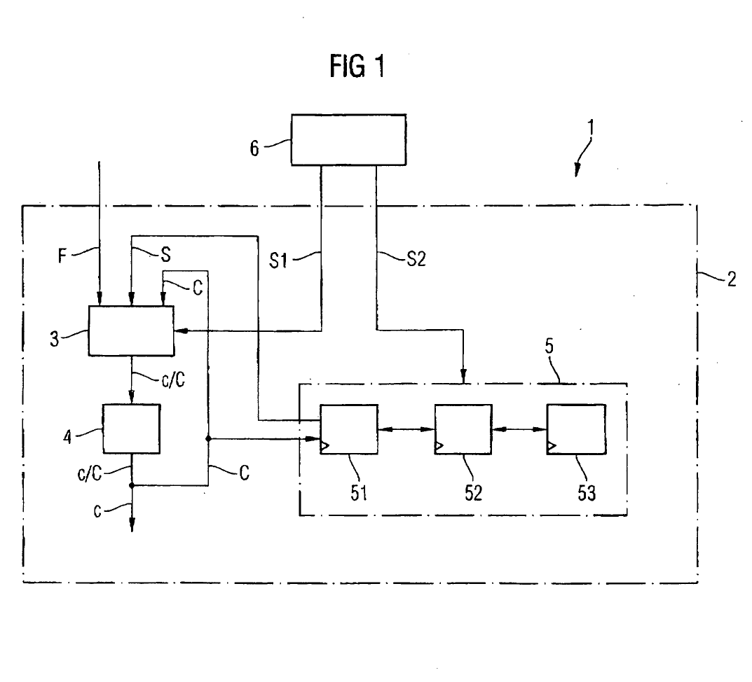

FIG. 1 shows a schematic block diagram of a preferred exemplary embodiment of the inventive processor 1 for the conditional execution of program commands. The processor 1 has a checking apparatus 2 for checking a condition c which is in the form of a logic function for a plurality of single conditions F; c1, c2, c3. As a result of the logic function for the plurality of single conditions F; c1, c2, c3, the condition c is preferably in the form of a complex or nested condition. The checking apparatus 2 checks the respective condition c. A program command preferably has a plurality of operations which can be executed particularly using a plurality of command execution units in the processor 1. Depending on the result of the check, the relevant program command or single operations in the program command are executed or the program command is identified as an NOP command and hence is not executed. The checked condition c thus indicates whether one or more operations in a program command which has been loaded and decoded by the processor 1 are to be executed. The processor 1 preferably has a pipeline architecture. Essentially, the processor's pipeline preferably has a command decoding/operand fetch unit for decoding a program command and for fetching operands addressed within the program command, a command execution unit for executing the decoded program command or some of its operations, and a write-back unit for writing back operational results from the executed program commands.

The inventive checking apparatus 2 has a control apparatus 3, a first register 4 and a register bank 5.

The control apparatus 3 checks the condition c or a subcondition C of the condition c in a predetermined i-th time unit on the basis of a first subcondition C, checked in the preceding (i−1)-th time unit, and a second subcondition S, checked in a time unit coming before the (i−1)-th time unit, and a single condition F; c1, c2, c3.

Equation 1 below shows a first exemplary embodiment of a condition c which is to be checked. If the result of the check returns a value of 1, for c, for example, then the relevant program command is executed. If the check gives a value of zero for the condition c, however, then the relevant program command is not executed.
c=(c1&c2)|(c3&c4&c5)| . . . , Equation 1:

The condition c comprises the single conditions c1 to c5. The AND function for the single conditions c1 and c2 is a subcondition C of the condition c. The AND function for the single conditions c3 to c5 is another subcondition C. If, by way of example, an (i−2)-th time unit is used to check the subcondition C=c1&c2 and the (i−1)-th time unit is used to check the subcondition C=c3&c4&c5 then the i-th time unit has both subconditions available for a logic OR function and hence for determining the final result for the condition c.

Preferably, the subcondition C is in the form of a logic function for one or more of the plurality of the single conditions.

Preferably, the time unit is in the form of a clock cycle for the process 1 or in the form of a predetermined portion of the clock cycle. By way of example, the sequence of the I time units, where iε[0, . . . , I−1], may therefore be in the form of a chronological sequence of the clock cycles for the process 1.

The first register 4 has its input side coupled to the control apparatus 3 for the purpose of storing the checked condition c or the checked subcondition C and has its output side coupled to the control apparatus 3 for the purpose of providing the stored, checked subcondition C as a checked, first subcondition C. The first register 4 is able to store one or more bits which can be used to represent the checked condition c or the checked subcondition C.

The input side of the register bank 5 is coupled to the first register 4 for the purpose of receiving the stored, checked subcondition C. The register bank 5 has at least a second register 51-52 for storing the received, checked subcondition C as a checked, second subcondition S (N=3). Without restricting the general nature, the register bank 5 has three second registers 51, 52, 53. The first of the second registers 51 stores the respective second subcondition S. The other second registers 52, 53 store further, already checked subconditions. In addition, the register bank 5 is coupled to the control apparatus 3 in order to provide the checked, second subcondition S.

Preferably, the register bank 5 is in the form of a line comprising a plurality N, where nε[1, . . . , N], of second registers 51-53. As stated, N is equal to 3 (N=3) in this exemplary embodiment as shown in FIG. 1. The first, where n=1, of the second registers 51 is coupled to the control apparatus 3 and to the first register 4 and stores the second subcondition S.

In addition, the line comprising the second registers 51-53 is preferably designed to store a predetermined plurality of the checked subconditions C in an order based on their check's respective time units.

Furthermore, the inventive processor 1 has a command decoding unit 6 which is coupled to the control apparatus 3 and/or to the register bank 5, which decodes a program command loaded by the processor 1 and which, on the basis of the decoded program command, provides a first control command S1 for the purpose of controlling the control apparatus 3 and/or a second control command S2 for the purpose of controlling the register bank 5.

Preferably, the command decoding unit 6 uses the first control command S1 to provide the control apparatus 3 with one or more rules V1-V6 for checking the condition c or the subcondition C. Table 1 below shows the rules V1-V6 and their respective functional description, presented in the notation of the known programming language C.

TABLE 1

| Rule | Functional description |
|---|---|
| V1 | C = −C |
| V2 | C = F |
| V3 | C& = F |
| V4 | C = S |
| V5 | C\| = S |
| V6 | C& = S |

The first rule V1 is used to update the first register 4 with a negation of the first subcondition C.

The second rule V2 is used to update the first register 4 with the single condition F.

The third rule V3 is used to update the first register 4 with a logic AND function for the first subcondition C and the single condition F.

The fourth rule V4 is used to update the first register 4 with the second subcondition S.

The fifth rule V5 is used to update the first register 4 with a logic OR function for the first subcondition C and the second subcondition S.

The sixth rule V6 is used to update the first register 4 with a logic AND function for the first subcondition C and the second subcondition S.

The current stored value in the first register 4 corresponds to the currently checked condition c or the currently checked subcondition C.

Preferably, the second control command S2 is in the form of a push command push or in the form of a pop command pop. The push command push is respectively used to update the n-th second register 52, 53 with a value from the (n−1)-th register 51, 52, which is upstream in the line, and the first second register 51 with the first subcondition C. The pop command pop is respectively used to update the n-th second register 51, 52 with a value from the (n+1)-th second register 52, 53, which is downstream in the line. By way of example, the value which is stored in the second register 52 is therefore pushed into the third second register 53 using the push command push and is pushed into the first second register 51 using the pop command pop.

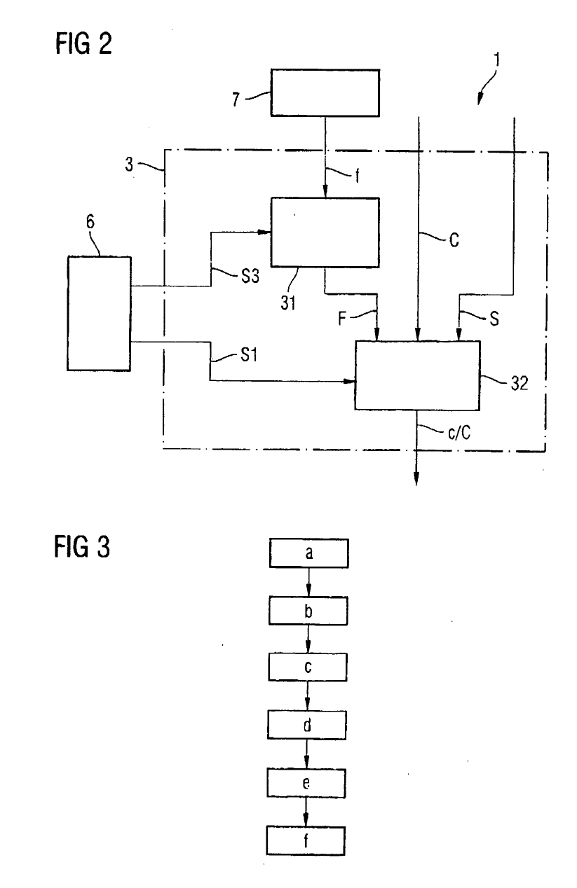

FIG. 2 shows a schematic block diagram of a preferred exemplary embodiment of the control apparatus 3 in the checking apparatus 2 based on the present invention. FIG. 2 shows, in particular, a more detailed illustration of the control apparatus 3 shown in FIG. 1.

Preferably, the control apparatus 3 has a first logic circuit 31 and/or a second logic circuit 32.

The first logic circuit 31 receives at least a status flag f1 from the processor 1 and, on the basis thereof, determines the single condition F. By way of example, the respective status flags f are stored in a status register 7 in the processor 1 and are provided by the latter. Alternatively, the respective status flags f can also be provided directly by a unit in the pipeline for the processor 1, for example the command execution unit, or by a pipeline register. Preferably, the first logic circuit 31 is controlled by the command decoding unit 6 using a third control command S3.

As illustrated above, the second logic circuit 32 is controlled by the command decoding unit 6 using the first control command S1 and, on the basis of the current single condition F, which has been provided by the first logic circuit 31, the first subcondition C, which has been provided by the first register 4, and the second condition S, which has been provided by the register bank 5, checks the current condition c or a further subcondition C of the condition c and provides the checked condition c or the checked subcondition C at the output.

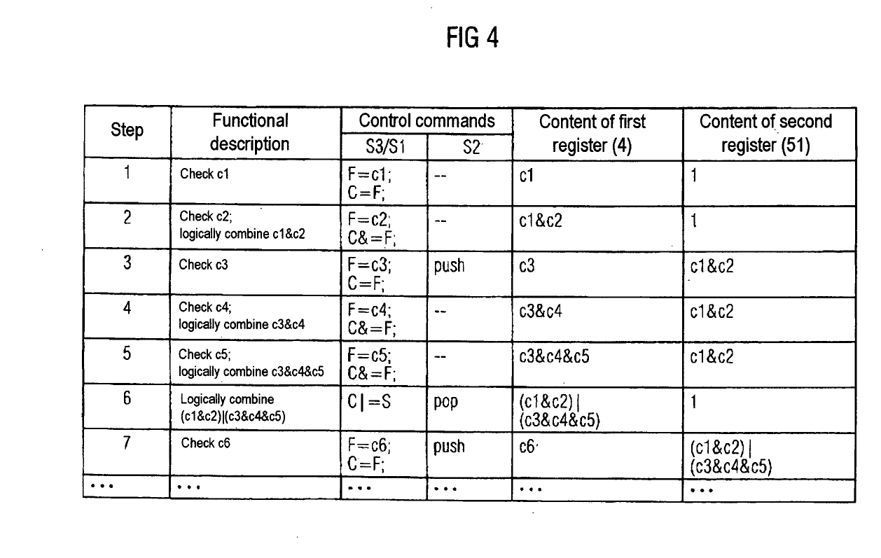

FIG. 3 shows a schematic flowchart of a preferred exemplary embodiment of the inventive method for checking the condition c for conditional execution of a program command which has been loaded and decoded by the processor 1, the condition c being in the form of a logic function for a plurality of single conditions F; c1, c2, c3.

The text below explains the inventive method with reference to the block diagram in FIG. 3. The inventive method has the following method levels:

Method Step a:

A subcondition C of the condition c is checked and the checked subcondition C is provided.

Method Step b:

The provided, checked subcondition C is stored as a second subcondition S.

Method Step c:

A further subcondition C of the condition c is checked and the checked further subcondition C is provided.

Method Step d:

The provided, checked further subcondition C is stored as a first subcondition C.

Method Step e:

A single condition F; c1, c2, c3 is provided.

Method Step f:

The condition c or a further subcondition C is checked on the basis of the stored, first subcondition C, the stored, second subcondition S and the provided single condition F.

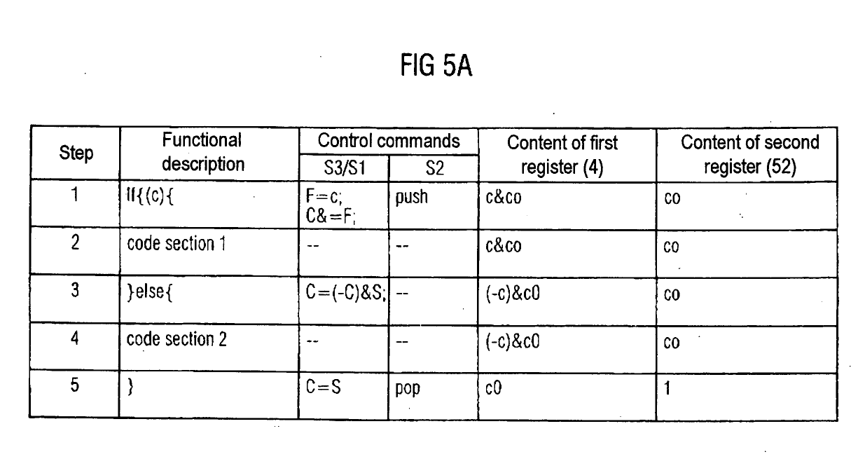

FIG. 4 shows a table to illustrate the inventive check on the first exemplary embodiment of a complex, nested condition c. The text below therefore shows how the condition c shown in equation 1 is checked in line with the invention with reference to FIG. 4.
c=(c1&c2)|(c3&c4&c5)| . . . , Equation 1:
Step 1:

The first logic circuit 31, controlled using the third control command S3, checks the single condition c1 of the condition c on the basis of at least a status flag f and provides the result at the output as code F or single condition F (F=c1).

The first control command S1, which is in the form of the second rule V2, controls the second logic circuit 32 such that the subcondition C is set to the single condition F, and the first register 4 is updated with this very single condition F. Since only a second register 51 in the register bank 5 is required for checking the condition c in line with equation 1, FIG. 4 also shows only the content of the second register 51. The second register S1 initially stores a default value, for example 1.

Step 2:

The first logic circuit 31 checks the single condition c2 and, at the output, sets the single condition F to the result of the check on c2. The first control command S, which is in the form of the third rule V3, controls the second logic circuit 32 such that the current subcondition C is set to the result of a logic AND function for the already checked, first subcondition C and the single condition F, and the first register 4 is updated with the value from the result. This therefore means that the first register 4 stores the subcondition C=c1&c2. The second register 31 also stores the default value 1.

Step 3:

As illustrated above, the single condition F is set to the single condition c3 of the condition c. The first control command S1, which is in the form of the second rule, controls the second logic circuit 32 such that the current subcondition C is set to the single condition F (C=F) and the first register 4 is updated with the single condition F. The second control command S2 is in the form of a push command push which prompts the content of the first register 4 (c1&c2), which was stored in step 2, to be pushed into the second register 51. The first register 4 therefore stores the value of the single condition c3 and the second register 51 stores the value of the AND function for c1 and c2.

Step 4:

The single condition F is set to the single condition c4 using the first logic circuit 31. The first control command S1, which is in the form of the third rule V3, controls the second logic circuit 32 such that the current subcondition C is set to the value of a logic AND function for the checked, first subcondition C, which is stored in the first register 4, and the single condition F (F=c4), and hence the first register 4 stores the result of the logic AND function c3&c4. The second register 51 continues to store the value from the logic AND function c1&c2.

Step 5:

The single condition F is set to the single condition c5 of the condition c using the first logic circuit 31. The first control command S1, which is in the form of the third rule V3, controls the second logic circuit 32 such that the current subcondition C is set to the value from a logic AND function for the single condition F (F=c5) and the content of the first register 4 (c3&c4&c5), and hence the first register 4 is updated with the value from the logic AND function c3&c4&c5. The second register 51 continues to store the value from the logic AND function c1&c2.

Step 6:

The first control command S1, which is in the form of the fifth rule V5, controls the second logic circuit 32 such that the first register 4 is updated with the result of a logic OR function for the checked, first subcondition C, which is stored in the first register 4, and the second subcondition S, which is stored in the second register 51. To this end, the second control command S2 is in the form of a pop command pop for providing the memory content of the second register 51. This means that the first register 4 therefore stores the result of the OR function (c1&c2)|(c3&c4&c5) and the second register 51 stores the default value 1.

Step 7:

The single condition F is set to the single condition c6 of the condition c using the first logic circuit 31. The first control command S1, which is in the form of the second rule V2, controls the second logic circuit 32 such that the first register 4 is updated with the single condition F (C=F). The second control command S2, which is in the form of a push command push, prompts the content of the first register 4 (c1&c2)|(c3&c4&c5), which was stored in step 5, to be pushed into the second register 51. The first register 4 therefore stores the value of the single condition c6 and the second register 51 stores the value of the OR function (c1&c2)|(c3&c4&c5).

This shows in detail how the condition c is checked in line with the invention.

Remembering that the value of the second subcondition S is always applied to the control apparatus 3, the invention produces the advantage that the rules V1-V6 from the first control command S for controlling the control apparatus 3 and hence the operations of the control apparatus 3 and the second control command S2 and hence the operations of the register bank 5 are orthogonal to one another and can therefore be executed independently of one another. The operations or commands on the register bank, push command push and pop command pop, are not time-critical. However, by way of example, step 2 uses a greater amount of execution time in the pipeline stage, for example in the command decoding unit, since for the time being the first logic circuit 31 is used to determine the single condition F and then the second logic circuit 32 is used to perform an AND function using the determined single condition F. However, a logic AND function in hardware is very fast, which means that it has only a negligibly small influence on a reduction in the speed. This means that each of the steps 1 to 7 presented above for checking the condition c can be carried out within one clock cycle, assuming that the respective single condition can be determined by the logic circuit 31 within one clock cycle.

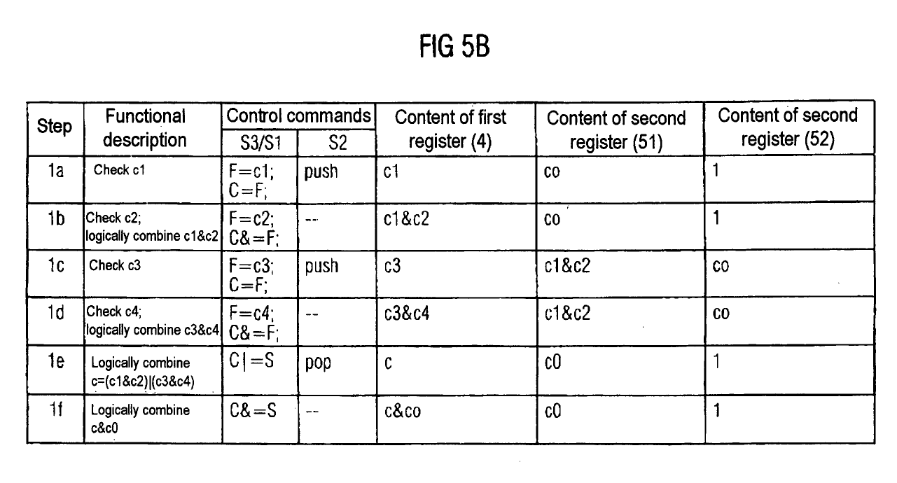

FIGS. 5a and 5b each show a table for illustrating an exemplary embodiment of a complex, nested condition. The text below is intended to show how the nested condition shown in source code 2 is checked in line with the invention.

Source code 2:

| | |
|---|---|
| If(a>b) | { |

| | |
|---|---|
| If(c==d) | { |

... ...

}else {

... ...

}

}else{

... ...

}

A nested condition generally has a multiplicity of levels comprising If loops and optionally If Else loops. The condition shown for source code 2 has two levels of If and Else loops. Assuming that the first code in the above C program (source code 2) has a (default) condition which has been set to 1 (true) as the start of the outer loop, the source code 2 can be shown as a nest of three levels. Each If and Else loop is accordingly situated on the inner level. This means that, in general, the inventive check on nested conditions requires, for the time being, a single If Else loop on the inner level, for example the inner If Else loop in the following source code (source code 4), to be checked:

Source code 4:

| | |
|---|---|
| If(c0) | { |

| ... ... | |
|---|---|
| If(c) | { |

code section 1

}else {

code section 2

}
... ...

}

Said loop pair is situated within a further loop with the condition c0, which is subsequently called the public condition for the outer loop. It has a separate condition c, which is subsequently called private conditions. The check on the condition or the setting of the condition for the inner loop pair implies the following operations:
setting the condition c0&c for “code section 1” in the If loop;
setting the condition c0&(−c) for “code section 2” in the Else loop; and
return to the public conditions c0 after the Else loop has ended.

The steps of checking for the condition of the source code 4 need to be carried out as illustrated in FIG. 5a. Since the check and the setting of the private condition c take priority, it turns out that they need to be carried out starting with step 1 (see FIG. 5a).

In addition, the invention takes account of the fact that the private condition c may also be a complex condition which may be formed from a plurality of single conditions, for example the conditions c1-c4 in equation 4 below.
c=(c1&c2)|(c3&c4) Equation 4:

If the private condition c is in the form of a complex condition of this kind—as illustrated in equation 4—then steps 1a-1f, as shown in FIG. 5b, can be carried out in similar fashion to the steps shown in FIG. 4.

Although the present invention has been described above with reference to the preferred exemplary embodiments, it is not limited thereto but rather can be modified in a wide variety of ways. By way of example, it is conceivable to align and/or expand the command set of the rules V1-V6 on the basis of the respective applications in the processor. In addition, the present invention, particularly the inventive checking apparatus for a processor, can also be applied to a processor which has a multiplicity of pipelines or a multiplicity of command execution units for executing program commands or operations in parallel. In such a case, only the first register 4 and the second registers 51 to 53 in the register bank 5 need to be expanded such that they store not just one respective bit but rather a vector of bits. In addition, the inventive control apparatus in the checking apparatus can be replicated on the basis of the number of pipelines for the processor, which means that the inventive control commands and operations can be applied to the relevant bit vectors, so that the same operation or the same command relates to all the bits of the bit vector uniformly in a particular time unit. The result which the first register 4 stores as a vector is then used as a mask for the conditional execution of the respective program command in the respective pipeline. Such parallelization can be applied both to a VLIW architecture and to an SIMD architecture.

What is claimed is:

1. A processor for conditional execution of program commands, comprising:
a checking device for checking a condition which is in the form of a logic function for a plurality of single conditions; wherein a checked condition indicates whether one or more operations in a program command which has been loaded and decoded by said processor are to be executed;
a control device checking said condition or a subcondition of said condition within a first time unit on the basis of a first subcondition checked within a second time unit preceding said first time unit, a second subcondition checked with a third time unit preceding said second time unit, and a single condition;
a first register comprising an input and an output; said input of said first register being coupled to said control device for storing said checked condition or subcondition and said output of said first register being coupled to said control device for providing said stored, checked subcondition as a checked, first subcondition; and
a register bank comprising an input and at least one second register; said input of said register bank being coupled to said first register for receiving said stored, checked subcondition, said at least one second register storing said received, checked subcondition as said checked, second subcondition, and said register bank being coupled to said control device for providing said checked, second subcondition.

2. The processor of claim 1, wherein said control device checks said condition or said subcondition of said condition in a predetermined i-th time unit on the basis of said first subcondition, checked in a preceding (i−1)-th time unit, and said second subcondition, checked in a time unit preceding said (i−1)-th time unit, and said relevant single condition.

3. The processor of claim 1, wherein said subcondition is in the form of a single condition or in the form of a logic function for a plurality of single conditions.

4. The processor of claim 1, wherein said register bank is in the form of a chain comprising a plurality of N second registers, wherein nε[1, . . . , N] and one of said second registers with n=1 is coupled to said control device and to said first register and stores said second subcondition.

5. The processor of claim 4, wherein said chain of second registers is designed to store a predetermined plurality of said checked subconditions in an order based on their check's respective time units.

6. The processor of claim 1, further comprising a command decoding device coupled to at least one of said control device or said register bank; said decoding device decoding a program command loaded by said processor and, on the basis of said decoded program command, providing at least one of a first control command for controlling said control device or a second control command for controlling said register bank.

7. The processor of claim 1, wherein said control device comprises at least one of
a first logic circuit which receives at least a status flag for said processor and determines said single condition on the basis thereof; or
a second logic circuit which, on the basis of said single condition, said first subcondition, and said second subcondition, checks said condition or said subcondition and provides said checked condition or subcondition.

8. The processor of claim 6, wherein said command decoding device uses said first control command to provide said control device with at least one rule for checking said condition or said subcondition; said rules being at least one of
a first rule used to update said first register with a negation for said first subcondition;
a second rule used to update said first register with said single condition;
a third rule used to update said first register with a logic AND function for said first subcondition and said single condition;
a fourth rule used to update said first register with said second subcondition;
a fifth rule used to update said first register with a logic OR function for said first subcondition and said second subcondition; and
a sixth rule used to update said first register with a logic AND function for said first subcondition and said second subcondition.

9. The processor of claim 7, wherein said command decoding device uses said first control command to provide said control device with at least one rule for checking said condition or said subcondition (; said rules being at least one of
a first rule used to update said first register with a negation for said first subcondition;
a second rule used to update said first register with said single condition;
a third rule used to update said first register with a logic AND function for said first subcondition and said single condition;
a fourth rule used to update said first register with said second subcondition;
a fifth rule used to update said first register with a logic OR function for said first subcondition and said second subcondition; and
a sixth rule used to update said first register with a logic AND function for said first subcondition and said second subcondition.

10. The processor of claims 6, wherein said second control command is a push command used to update each of said n-th second registers with a value from the relevant of said (n−1)-th registers and said first second register with said first subcondition.

11. The processor of claims 6, wherein said second control command is a pop command, which is used to update each of said n-th second register with a value from said (n+1)-th second register connected downstream in said chain.

12. The processor of claim 1, wherein said time unit is a clock cycle in said processor or a predetermined portion of said clock cycle.

13. A method for checking a condition for conditional execution of one or more operations in a program command, comprising the steps of:
providing a checked condition by checking a subcondition of a condition which has been loaded and decoded by a processor; said condition being in the form of a logic function for a plurality of single conditions;
storing said checked subcondition as a second subcondition;
providing a further checked condition by checking a further subcondition of said condition;
storing said further checked subcondition as a first subcondition;
providing a single condition; and
checking said condition or a further subcondition on the basis of said stored, first subcondition, said stored, second subcondition, and said provided single condition.
